(19) United States
(12) Patent Application Publication
(10) Pub. No.: US 2016/0364719 A1
(43) Pub. Date: Dec. 15, 2016

(54) USER EQUIPMENT FOR REVERSE NFC PAYMENT, NFC PAYMENT TERMINAL, REVERSE NFC PAYMENT SYSTEM COMPRISING THE SAME, CONTROL METHOD THEREOF AND NON-TRANSITORY COMPUTER READABLE STORAGE MEDIUM HAVING COMPUTER PROGRAM RECORDED THEREON

(71) Applicant: SK PLANET CO., LTD., Seongnam-si (KR)

(72) Inventor: Jae Sic JEON, Seoul (KR)

(21) Appl. No.: 14/950,491

(22) Filed: Nov. 24, 2015

(30) Foreign Application Priority Data
Jun. 11, 2015 (KR) 10-2015-0082389

(51) Int. Cl. G06Q 20/32; G06Q 20/40; G06Q 20/38

(52) U.S. Cl. CPC G06Q 20/3278; G06Q 20/3223; G06Q 20/382; G06Q 20/40

(57) ABSTRACT

Provided are a user equipment for reverse NFC payment, an NFC payment terminal, a reverse NFC payment system including the same, a control method thereof, and a non-transitory computer readable storage medium having a computer program recorded thereon. That is, according to the present invention, since a user equipment operates as a reader/writer and an NFC payment terminal (or POS terminal) operates as a card so as to execute a payment function, it is possible to simplify a payment process and thus possible to improve satisfaction of a user. Further, it is possible to autonomously provide a mobile card service without making an alliance or settling costs with a mobile carrier or mobile phone manufacturer. Thus, it is possible to unify customer management and also reduce costs required to issue cards.

### CROSS-REFERENCE TO RELATED APPLICATION

This application claims the benefit of Korean Application No. 10-2015-0082389 filed on Jun. 11, 2015 with the Korean Intellectual Property Office, the disclosure of which is incorporated herein by reference.

### BACKGROUND OF THE INVENTION

### 1. Field of the Invention

The present invention relates to a user equipment for reverse NFC payment, an NFC payment terminal, a reverse NFC payment system including the same, a control method thereof, and a non-transitory computer readable storage medium having a computer program recorded thereon, and more particularly, to a user equipment for reverse NFC payment, an NFC payment terminal, a reverse NFC payment system including the same, a control method thereof, and a non-transitory computer readable storage medium having a computer program recorded thereon capable of executing a payment function by the user equipment operating as a reader/writer and the NFC payment terminal (or POS terminal) operating as a card.

### 2. Description of the Related Art

Payment service providers who want to provide payment services using mobile phones provide mobile payment services by using barcode, magnetic stripe transmission, NFC (Near Field Communication), and Bluetooth technologies.

In the case of mobile payment using NFC, a mobile phone serves as a card (a card or a tag) and an NFC payment device connected with a POS terminal serves as a reader/writer. Further, a USIM (Universal Subscriber Identity Module) or an SE (Secure Element) mounted in the mobile phone must be used. In this case, it is essential to make an alliance with a managing entity of the USIM (Universal Subscriber Identity Module) or the SE (Secure Element).

Accordingly, a financial company such as a card company must proceed with business in alliance with a mobile carrier or manufacturer that manages the USIM or the SE. Therefore, there exists a barrier (or an entry barrier) to activation of business.

### SUMMARY OF THE INVENTION

An object of the present invention is to provide a user equipment for reverse NFC payment, an NFC payment terminal, a reverse NFC payment system including the same, a control method thereof, and a non-transitory computer readable storage medium having a computer program recorded thereon capable of executing a payment function by the user equipment operating as a reader/writer and the NFC payment terminal (or POS terminal) operating as a card.

Another object of the present invention is to provide a user equipment for reverse NFC payment, an NFC payment terminal, a reverse NFC payment system including the same, a control method thereof, and a non-transitory computer readable storage medium having a computer program recorded thereon for providing an open payment system capable of autonomously executing a payment function without being affected by a mobile carrier or mobile phone manufacturer that manages and controls a USIM (Universal Subscriber Identity Module) or an SE (Secure Element).

According to an aspect of the present invention, control method of a user equipment includes: reading, by means of a control unit of the user equipment, an unpredictable number (UN) stored in a secure element (SE) of an NFC payment terminal by tagging the NFC payment terminal; generating, by means of the control unit of the user equipment, an authentication value by encoding the read unpredictable number and a credit card number and an ATC(Application Transaction Counter) stored in a storage unit of the user equipment through the authentication value generation key stored in the storage unit of the user equipment; and recording, by means of the control unit of the user equipment, card information including the credit card number and the generated authentication value in the SE of the NFC payment terminal.

According to another aspect of the present invention, a reverse NFC payment system includes: an NFC payment terminal configured to operate in a predetermined card emulation mode in order to operate as a card, generate an unpredictable number required to generate payment authentication information, and store the generated unpredictable number in an SE; and a user equipment configured to operate in a predetermined reader/writer mode in order to operate as a reader/writer, read the unpredictable number stored in the SE of the NFC payment terminal, generate an authentication value by encoding the read unpredictable number, a credit card number, and an ATC through an authentication value generation key, and records card information including the credit card number and the generated authentication value in the SE of the NFC payment terminal.

In an embodiment of the present invention, the user equipment may perform the authentication value generation process within a predetermined secure area of the user equipment.

In an embodiment of the present invention, the reverse NFC payment system may further include: a payment server configured to receive the card information and the unpredictable number stored in the SE and transmitted from the NFC payment terminal, generate an authentication verification value by encoding the received card information and unpredictable number and an ATC previously stored in the payment server through an authentication value generation key previously stored in the payment server in order to verify the card information, and checks whether the authentication value in the card information transmitted from the NFC payment terminal is identical with the generated authentication verification value.

In an embodiment of the present invention, when the authentication value in the card information transmitted from the NFC payment terminal is not identical with the generated authentication verification value, the payment server may transmit transaction failure information to the NFC payment terminal, and the NFC payment terminal may receive the transaction failure information transmitted from the payment server and display the received transaction failure information.

In an embodiment of the present invention, when the authentication value in the card information transmitted from the NFC payment terminal is identical with the generated authentication verification value, the payment server may determine a transaction as normal and transmit transaction approval information to the NFC payment terminal, and the NFC payment terminal may receive the transaction approval information transmitted from the payment server and display the received transaction approval information.

According to yet another aspect of the present invention, a control method of a reverse NFC payment system includes: operating in a predetermined card emulation mode in order to operate as a card and generating an unpredictable number required to generate payment authentication information, by means of an NFC payment terminal; storing the generated unpredictable number in an SE, by the NFC payment terminal; operating in a predetermined reader/writer mode in order to operate as a reader/writer and reading the unpredictable number stored in the SE of the NFC payment terminal after tagging the NFC payment terminal, by means of a user equipment; generating an authentication value by encoding the read unpredictable number, a credit card number, and an ATC through an authentication value generation key, by means of the user equipment; and recording card information including the credit card number and the generated authentication value in the SE of the NFC payment terminal, by means of the user equipment.

In an embodiment of the present invention, the authentication value generation key is stored in a predetermined secure area of the user equipment or a storage unit of a cloud server.

In an embodiment of the present invention, the control method of a reverse NFC payment system may further include: transmitting the card information and the unpredictable number stored in the SE of the NFC payment terminal to a payment server, by means of the NFC payment terminal; generating an authentication verification value by encoding the transmitted card information and unpredictable number and an ATC previously stored in the payment server through an authentication value generation key previously stored in the payment server in order to verify the card information, by means of the payment server; checking whether the authentication value in the card information transmitted from the NFC payment terminal is identical with the generated authentication verification value, by means of the payment server; as a result of checking, when the authentication value in the card information transmitted from the NFC payment terminal is identical with the generated authentication verification value, determining a transaction as normal and transmitting transaction approval information to the NFC payment terminal, by means of the payment server; and displaying the transaction approval information transmitted from the payment server, by means of the NFC payment terminal.

In an embodiment of the present invention, the control method of a reverse NFC payment system may further include: as a result of checking, when the authentication value in the card information transmitted from the NFC payment terminal is not identical with the generated authentication verification value, transmitting transaction failure information to the NFC payment terminal, by means of the payment server; and displaying the transaction failure information transmitted from the payment server, by means of the NFC payment terminal.

In an embodiment of the present invention, recording card information includes: generating, by means of the user equipment while operating in a predetermined reader/writer mode, the card information including the credit card number and the generated authentication value; and recording, by means of the user equipment, the generated card information in the SE of the NFC payment terminal.

According to still another aspect of the present invention, a computer program for executing the control method according to the aforementioned embodiments may be stored in a non-transitory computer readable storage medium having a computer program recorded thereon.

As described above, according to the present invention, since a user equipment operates as a reader/writer and an NFC payment terminal (or POS terminal) operates as a card so as to execute a payment function, it is possible to simplify a payment process and thus possible to improve satisfaction of a user.

Further, since the present invention provides an open payment system capable of autonomously executing a payment function without being affected by a mobile carrier or mobile phone manufacturer that manages and controls a USIM (Universal Subscriber Identity Module) or an SE (Secure Element), it is possible to autonomously provide a mobile card service without making an alliance or settling costs with the mobile carrier or mobile phone manufacturer. Thus, it is possible to unify customer management and also reduce costs required to issue cards.

### BRIEF DESCRIPTION OF THE DRAWINGS

FIG. 1 is a block diagram illustrating a configuration of a reverse NFC payment system according to an embodiment of the present invention.

FIG. 2 is a block diagram illustrating a configuration of an NFC payment terminal according to an embodiment of the present invention.

FIG. 3 is a block diagram illustrating a configuration of a user equipment according to an embodiment of the present invention.

FIG. 4 is a flowchart illustrating a control method of a reverse NFC payment system according to a first embodiment of the present invention.

FIG. 5 to FIG. 6 are diagrams each illustrating a screen of a user equipment according to the embodiment of the present invention.

FIG. 7 is a diagram illustrating a screen of an NFC payment terminal according to the embodiment of the present invention.

FIG. 8 is a flowchart illustrating a control method of a reverse NFC payment system according to the second embodiment of the present invention.

FIG. 9 is a flowchart illustrating a control method of a reverse NFC payment system according to a third embodiment of the present invention.

### DETAILED DESCRIPTION OF THE PREFERRED EMBODIMENTS

It is noted that technical terms used in the present invention are used to just describe a specific embodiment and do not intend to limit the present invention. Further, if the technical terms used in the present invention are not particularly defined as other meanings in the present invention, the technical terms should be appreciated as meanings generally appreciated by those skilled in the art and should not be appreciated as excessively comprehensive meanings or excessively reduced meanings. Further, when the technical term used in the present invention is a wrong technical term that does not accurately express the spirit of the present invention, the technical term should be understood by being substituted by a technical term which can be correctly understood by those skilled in the art. In addition, a general term used in the present invention should be interpreted as defined in a dictionary or contextually, and should not be interpreted as an excessively reduced meaning.

In addition, singular expressions used in the present invention include plurals expressions unless they have definitely opposite meanings. In the present invention, it should not analyzed that a term such as “comprising” or “including” particularly includes various components or various steps disclosed in the specification and some component or some steps among them may not included or additional components or steps may be further included.

In addition, terms including ordinal numbers, such as ‘first’ and ‘second’, used in the present invention can be used to describe various components, but the components should not be limited by the terms. The above terms are used only to discriminate one component from the other components. For example, a first component may be named a second component and similarly, the second component may also be named the first component, without departing from the scope of the present invention.

Hereinafter, preferable exemplary embodiment of the present invention will be described in more detail with reference to the accompanying drawings. Like reference numerals refer to like elements for easy overall understanding and a duplicated description of like elements will be omitted.

Further, in the following description, a detailed explanation of known related technologies may be omitted to avoid unnecessarily obscuring the subject matter of the present invention. Further, it is noted that the accompanying drawings are only for easily understanding the spirit of the present invention and it should not be interpreted that the spirit of the present invention is limited by the accompanying drawings.

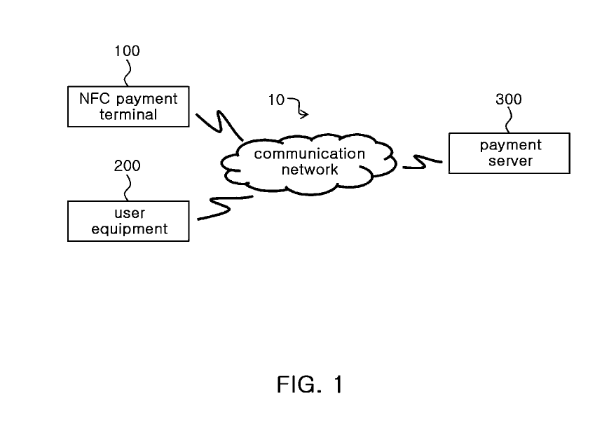

FIG. 1 is a block diagram illustrating a configuration of a reverse NFC payment system 10 according to an embodiment of the present invention.

As illustrated in FIG. 1, the reverse NFC payment system 10 is constituted by an NFC payment terminal 100, a user equipment 200, and a payment server 300. All the constituent elements of the reverse NFC payment system 10 illustrated in FIG. 1 are not essential constituent elements, and the reverse NFC payment system 10 may be implemented by more constituent elements than the constituent elements illustrated in FIG. 1 or less constituent elements therethan.

The NFC payment terminal 100 generates an unpredictable number and stores the unpredictable number therein. Then, when the user equipment 200 touches the NFC payment terminal 100, the user equipment 200 reads the unpredictable number stored in the NFC payment terminal 100. Then, the user equipment 200 generates an authentication value by encoding the unpredictable number read from the NFC payment terminal 100 and a credit card number and an ATC (Application Transaction Counter) previously stored in the corresponding user equipment 200 through a preset authentication value generation key. Then, the user equipment 200 stores card information including the credit card number and the generated authentication value in the NFC payment terminal 100. Then, the NFC payment terminal 100 reads the stored card information and unpredictable number and transmits the read card information and unpredictable number to the payment server 300. Then, the payment server 300 generates an authentication verification value by encoding the card information and unpredictable number transmitted from the NFC payment terminal 100 and an ATC previously stored in the payment server 300 through a preset authentication value generation key in order to verify the card information transmitted from the NFC payment terminal 100. Then, if the authentication value included in the card information transmitted from the NFC payment terminal 100 is identical with the authentication verification value generated by the payment server 300, the payment server 300 transmits transaction approval information to the NFC payment terminal 100. Further, the NFC payment terminal 100 receives the transaction approval information transmitted from the payment server 300 and displays the received transaction approval information.

The NFC payment terminal 100 may be a terminal interworking with a POS (Point of Sales) terminal or may be a POS terminal.

Further, the NFC payment terminal 100 is provided (or installed) in any store.

Further, the NFC payment terminal 100 provides (or transmits) product information to one or more user equipments 200 positioned in (or entering) the store through a beacon (not illustrated) provided at each of a plurality of locations in the store. Herein, the product information includes a product name, a product identity code, a product image, a product specification, and the like.

Further, the NFC payment terminal 100 receives order information transmitted from the user equipment 200 of a user visiting the store provided with the NFC payment terminal 100. In this case, the NFC payment terminal 100 may receive the corresponding order information via a beacon adjacent to the user equipment 200. Herein, the order information includes a name of an ordered product (or a name of an ordered menu/a name of an ordered food), an identity code of the ordered product, an order quantity (or a quantity of each product), a table number, identification information of the user equipment 200, and the like. Herein, the identification information of the user equipment 200 includes an MDN (Mobile Directory Number), a mobile IP, a mobile MAC, an SIM (Subscriber Identity Module) card unique information, serial number, and the like.

Further, after providing a product or a service corresponding to the corresponding ordered information, the NFC payment terminal 100 communicates with the corresponding user equipment 200 when the corresponding user equipment 200 tries to execute a payment function.

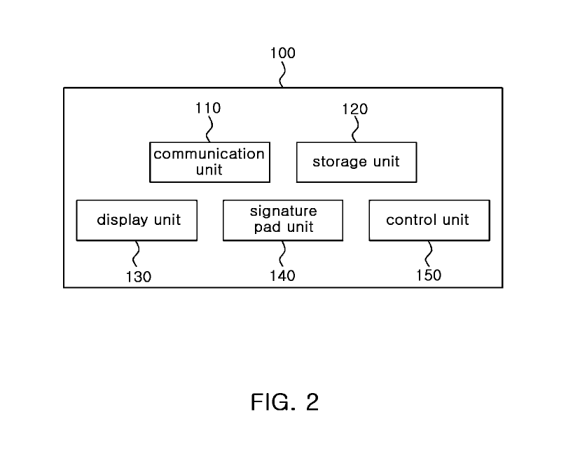

As illustrated in FIG. 2, the NFC payment terminal 100 is constituted by a communication unit 110, a storage unit 120, a display unit 130, a signature pad unit 140, and a control unit 150. All the constituent elements of the NFC payment terminal 100 illustrated in FIG. 2 are not essential constituent elements, and the NFC payment terminal 100 may be implemented by more constituent elements than the constituent elements illustrated in FIG. 2 or less constituent elements therethan.

The communication unit 110 communicates with any internal constituent element or at least any one external terminal via a wired/wireless communication network. In this case, the external terminal may include a POS terminal, the user equipment 200, the payment server 300, and the like. Herein, a wireless internet technology may include wireless LAN (WLAN), DLNA (Digital Living Network Alliance), Wibro (Wireless Broadband), Wimax (World Interoperability for Microwave Access), HSDPA (High Speed Downlink Packet Access), HSUPA (High Speed Uplink Packet Access), IEEE 802.16, Long Term Evolution (LTE), LTE-A (Long Term Evolution-Advanced), Wireless Mobile Broadband Service (WMBS), and the like. The communication unit 110 transmits and receives data according to at least one wireless internet technology in a range including the internet technologies which are not described above. Further, a short range communication technology may include Bluetooth, RFID (Radio Frequency Identification), Infrared Data Association (IrDA), UWB (Ultra Wideband), ZigBee, Near Field Communication (NFC), Ultra Sound Communication (USC), Visible Light Communication (VLC), Wi-Fi, Wi-Fi Direct, and the like. Further, a wired communication technology may include Power Line Communication (PLC), USB communication, Ethernet, serial communication, hybrid fiber/coaxial cable, and the like.

Further, the communication unit 110 may mutually transmit information with any terminal through a universal serial bus (USB).

Further, the communication unit 110 transmits and receives wireless signals to and from a base station, the POS terminal, the user equipment 200, the payment server 300, and the like in a mobile communication network, which is constructed according to technical standards or communication methods for mobile communications (for example, GSM (Global System for Mobile communication), CDMA (Code Division Multi Access), CDMA 2000 (Code Division Multi Access 2000), EV-DO (Enhanced Voice-Data Optimized or Enhanced Voice-Data Only), WCDMA (Wideband CDMA), HSDPA (High Speed Downlink Packet Access), HSUPA (High Speed Uplink Packet Access), LTE (Long Term Evolution), LTE-A (Long Term Evolution-Advanced), and the like).

Further, the communication unit 110 is connected with the user equipment 200 by NFC by the control of the control unit 150.

The storage unit 120 stores various user interfaces (UI), graphic user interfaces (GUI), and the like therein.

Further, the storage unit 120 stores data and programs required to operate the NFC payment terminal 100.

That is, the storage unit 120 may store various application programs or applications to be executed in the NFC payment terminal 100 and data and instructions for operating the NFC payment terminal 100. At least some of the application programs can be downloaded from an external server through wireless communication. Further, at least some of the application programs may be present in the NFC payment terminal 100 from the time of release in order for the NFC payment terminal 100 to execute basic functions (for example, a call receiving/sending function and a message receiving/sending function). Meanwhile, the application programs may be stored in the storage unit 120, and installed in the NFC payment terminal 100 and driven by the control unit 150 so as to execute operations (or functions) of the NFC payment terminal 100.

Further, the storage unit 120 may include at least one storage medium of memories of flash memory type, hard disk type, multimedia card micro type, and card type (for example, a SD or XD memory), magnetic memories, magnetic disks, optical disks, RAM (Random Access Memory), SRAM (Static Random Access Memory), ROM (Read-Only Memory), EEPROM (Electrically Erasable Programmable Read-Only Memory), and PROM (Programmable Read-Only Memory). Further, the NFC payment terminal 100 may manage a web storage that executes a storage function of the storage unit 120 on the Internet, or may operate in association with the web storage.

Further, the storage unit 120 may store an unpredictable number or the like generate by the control of the control unit 150.

Further, the storage unit 120 may be an SE (Secure Element) as a storage medium. Herein, the SE serves as a security module and stores (or manages) information for a payment function, a customer information management function, and the like.

The display unit 130 may display various contents such as various menu screens by using the UI and/or GUI stored in the storage unit 120 by the control of the control unit 150. Herein, the contents displayed on the display unit 130 may include menu screens including various texts or image data (including various information data) and data such as icons, a list menu, a combo box, and the like. Further, the display unit 130 may be a touch screen.

Further, the display unit 130 may include as at least one of a liquid crystal display (LCD), a thin film transistor-liquid crystal display (TFT-LCD), an organic light-emitting diode (OLED), a flexible display, a 3D display, an e-ink display, and a light emitting diode (LED).

Further, the display unit 130 displays a payment function execution status according to execution of the payment function of the user equipment 200 by the control of the control unit 150. Herein, the payment function execution status includes transaction failure information (transaction failure message) or transaction approval information (transaction approval message) indicating success or failure of the payment function.

Further, the NFC payment terminal 100 may further include an audio output unit (not illustrated) configured to output audio information included in a signal to which a predetermined signal process is performed by the control of the control unit 150. Herein, the audio output unit may include a receiver, a speaker, a buzzer, and the like.

Further, the audio output unit outputs an audio guidance generated by the control unit 150.

Further, the audio output unit outputs, by control of the control unit 150, audio information corresponding to the payment function execution status according to execution of the payment function of the user equipment 200.

The signature pad unit 140 is configured to receive signature information when the user equipment 200 executes the payment function.

Further, the signature pad unit 140 receives signature information according to a user input (or touch input) of the user equipment 200.

The control unit 150 performs an overall control function for the NFC payment terminal 100.

Further, the control unit 150 performs the overall control function for the NFC payment terminal 100 by using programs and data stored in the storage unit 120. The control unit 150 may include a RAM, a ROM, a CPU, a GPU, and a bus, and the RAM, the ROM, the CPU, the GPU, and the like may be connected with each other by the bus. The CPU may access the storage unit 120 and perform booting by using an 0/S stored in the storage unit 120 and perform various operations by using various programs, contents, data, and the like stored in the storage unit 120.

Further, the control unit 150 generates an unpredictable number (UN) required to generate payment authentication information. In this case, the control unit 150 operates in a predetermined card emulation mode in order to operate as a card.

That is, in the predetermined card emulation mode, the control unit 150 generates an unpredictable number (or an unpredictable number value) required to generate payment authentication information.

Further, the control unit 150 stores the generated unpredictable number in the storage unit 120 (particularly, SE).

Further, if the NFC payment terminal 100 is touched (or tagged/recognized) by the user equipment 200, the control unit 150 transmits the unpredictable number recorded in the storage unit 120 to the user equipment 200 by interworking with the user equipment 200 (or the unpredictable number recorded in the storage unit 120 is read by the user equipment 200).

Further, the card information generated by the user equipment 200 is recorded in the corresponding storage unit 120. Herein, the card information includes a credit card number issued to the user equipment 200, an authentication value generated by the user equipment 200, and the like.

As such, when the payment function is executed, the NFC payment terminal 100 may interwork with the user equipment 200, so that the unpredictable number recorded in the storage unit 120 may be read by the user equipment 200 or the card information generated by the user equipment 200 may be recorded in the storage unit 120.

Further, the control unit 150 transmits, through the communication unit 110, the card information recorded in the storage unit 120, the unpredictable number stored in the storage unit 120, and the like to the payment server 300.

Further, the control unit 150 receives, through the communication unit 110, transaction failure information transmitted from the payment server 300 in response to the transmitted card information and unpredictable number.

Further, the control unit 150 receives, through the communication unit 110, transaction approval information transmitted from the payment server 300 in response to the transmitted card information and unpredictable number.

Further, the control unit 150 displays the received transaction failure information and transaction approval information through the display unit 130.

Further, if a transaction is normally approved, the control unit 150 receives, through the communication unit 110, a payment function execution result (or payment information) transmitted from the payment server 300. Herein, the payment information includes a store name, a location of the store, contact information of the store, order information, payment date and time information, price information for each ordered product, and the like.

Further, the control unit 150 displays the received payment function execution result (or payment information) through the display unit 130.

Further, the control unit 150 transmits the received payment function execution result (or payment information) to the user equipment 200 through the communication unit 110.

Further, the control unit 150 outputs the received payment function execution result (or payment information) in the form of a receipt and provides the receipt to a user of the corresponding user equipment 200. Herein, the corresponding receipt may further include a discount coupon, a free coupon, or the like in addition to the corresponding payment function execution result.

The NFC payment terminal 100 according to an embodiment of the present invention may further include a tag unit (not illustrated). Herein, the tag unit may include an antenna (not illustrated) for communication with other external devices (including, for example, the user equipment 200, and the like).

Further, if the tag unit is tagged (for example, NFC tagged) by the user equipment 200, the corresponding user equipment 200 may read the unpredictable number stored in the NFC payment terminal 100.

Herein, as communication between the NFC payment terminal 100 and the user equipment 200, NFC is used.

Herein, the NFC method is a communication method based on the 13.56 MHz contactless standard.

Further, the corresponding NFC method has a communication range of less than 10 cm and a data rate of 106 Kbps, 212 Kbps, 424 Kbps, or 848 Kbps.

Further, the corresponding NFC method includes three operation modes including a card emulation mode, a reader/writer mode, and a peer to peer mode. Each operation mode includes a card function, a read/write function, an initiator function, a target function, and the like.

Further, the NFC payment terminal 100 in the card emulation mode operates as a contactless card, and may execute an integrated payment function, a credit payment function, a transportation payment function, and the like.

That is, the NFC payment terminal 100 in the card emulation mode serves as a passive tag and communicates with an external active reader.

Further, the NFC payment terminal 100 in the reader/writer mode is in an active state and may execute a function of reading a passive NFC tag, a function of recording information in the corresponding NFC tag, and the like.

That is, the NFC payment terminal 100 in the reader/writer mode executes a function of recognizing an NFC tag and reading data in the NFC tag or writing (or recording) data in the NFC tag.

Further, the NFC payment terminal 100 in the peer to peer mode communicates with another NFC payment terminal, and transmits and receives information (or contents).

That is, the NFC payment terminal 100 in the peer to peer mode executes a function of data transmission between NFC devices (including, for example, exchange of contents, exchange of photos, exchange of business cards, and the like.).

The NFC method can be applied to a home network control service, a user equipment-PC/TV synchronization service, a refueling and vehicle maintenance record tracking service, a subway fare payment service (or mobile ticketing service for public transportation) or a quick money transfer service, an order and payment service from a seat at a restaurant, a music download or movie/sport reservation service via a poster (or service of reading a tag in an outdoor billboard via a smart poster and recognizing advertisement information), a coupon/membership use service at a coffee shop, a quick shopping service at an unmanned store, an ID card use service for entry into home/office, a data exchange service between user equipments or a printer connection service, a mobile payment service (with, for example, a debit card/credit card), and the like.

Further, the NFC payment terminal 100 adopting the NFC method can be easily connected with the other terminal (for example, the user equipment 200) by touching or tagging the NFC payment terminal 100 by means of automatic pairing.

Further, a USIM-based NFC service may be applied to an electronic wallet service (including, for example, membership, coupon, ticket services), a public transportation and retail payment service, a cash receiving/paying service, an online/offline payment service, a health care service, a medical record transmission service, an ID card/print card service, a performance ticketing service, a parking location service, and the like.

The user equipment 200 can be applied to various terminals such as smart phones, portable terminals, mobile terminals, personal digital assistants (PDA), PMP (Portable Multimedia Player) terminals, telematics terminals, navigation terminals, personal computers, notebook computers, slate PCs, tablet PCs, ultrabook, wearable devices (including, for example, smart watch, smart glass, HMD (Head Mounted Display), and the like), Wibro terminals, IPTV (Internet Protocol Television) terminals, smart TVs, digital broadcasting terminals, televisions, 3D televisions, home theater systems, AVN (Audio Video Navigation) terminals, A/V (Audio/Video) systems, flexible terminals, and the like.

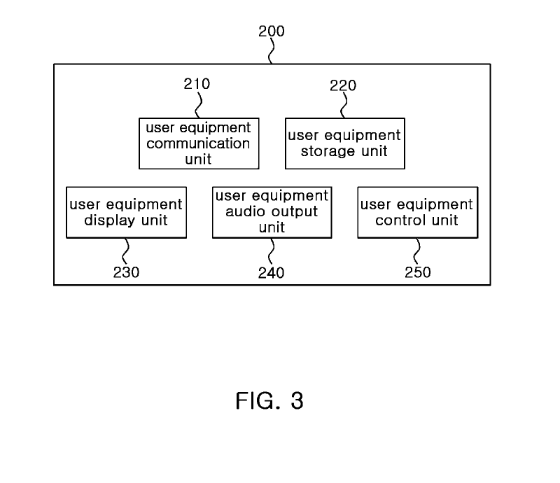

As illustrated in FIG. 3, the user equipment 200 is constituted by a user equipment communication unit 210, a user equipment storage unit 220, a user equipment display unit 230, a user equipment audio output unit 240, and a user equipment control unit 250. All the constituent elements of the user equipment 200 illustrated in FIG. 3 are not essential constituent elements, and the user equipment 200 may be implemented by more constituent elements than the constituent elements illustrated in FIG. 3 or less constituent elements therethan.

The user equipment communication unit 210 communicates with any internal constituent element or at least any one external terminal via a wired/wireless communication network. In this case, the external terminal may include a POS terminal, the NFC payment terminal 100, the payment server 300, and the like. Herein, a wireless internet technology may include wireless LAN (WLAN), DLNA, Wibro, Wimax, HSDPA, HSUPA, IEEE 802.16, Long Term Evolution (LTE), LTE-A, Wireless Mobile Broadband Service (WMBS), and the like. The user equipment communication unit 210 transmits and receives data according to at least one wireless internet technology in a range including the internet technologies which are not described above. Further, a short range communication technology may include Bluetooth, RFID, Infrared Data Association (IrDA), UWB, ZigBee, Near Field Communication (NFC), Ultra Sound Communication (USC), Visible Light Communication (VLC), Wi-Fi, Wi-Fi Direct, and the like. Further, a wired communication technology may include Power Line Communication (PLC), USB communication, Ethernet, serial communication, hybrid fiber/coaxial cable, and the like.

Further, the user equipment communication unit 210 may mutually transmit information with any terminal through a universal serial bus (USB).

Further, the user equipment communication unit 210 transmits and receives wireless signals to and from a base station, the POS terminal, the NFC payment terminal 100, the payment server 300, and the like in a mobile communication network, which is constructed according to technical standards or communication methods for mobile communications (for example, GSM, CDMA, CDMA 2000, EV-DO, WCDMA, HSDPA, HSUPA, LTE, LTE-A, and the like).

Further, the user equipment communication unit 210 is connected with the NFC payment terminal 100 by NFC by the control of the user equipment control unit 250.

Further, the user equipment communication unit 210 transmits a credit card number issued to the corresponding user equipment 200 for executing a payment function, identification information of the user equipment 200, and the like to the NFC payment terminal 100 by the control of the user equipment control unit 250. Herein, the identification information of the user equipment 200 includes an MDN (Mobile Directory Number), a mobile IP, a mobile MAC, an SIM (Subscriber Identity Module) card unique information, serial number, and the like.

The user equipment storage unit 220 stores various user interfaces (UI), graphic user interfaces (GUI), and the like therein.

Further, the user equipment storage unit 220 stores data and programs required to operate the user equipment 200.

That is, the user equipment storage unit 220 may store various application programs or applications to be executed in the user equipment 200 and data and instructions for operating the user equipment 200. At least some of the application programs can be downloaded from an external server through wireless communication. Further, at least some of the application programs may be present in the user equipment 200 from the time of release in order for the user equipment 200 to execute basic functions (for example, a call receiving/sending function and a message receiving/sending function). Meanwhile, the application programs may be stored in the user equipment storage unit 220, and installed in the user equipment 200 and driven by the user equipment control unit 250 so as to execute operations (or functions) of the user equipment 200.

Further, the user equipment storage unit 220 may include at least one storage medium of memories of flash memory type, hard disk type, multimedia card micro type, and card type (for example, a SD or XD memory), magnetic memories, magnetic disks, optical disks, RAM, SRAM, ROM, EEPROM, and PROM. Further, the user equipment 200 may manage a web storage that executes a storage function of the user equipment storage unit 220 on the Internet, or may operate in association with the web storage.

Further, the user equipment storage unit 220 stores, by the control of the user equipment control unit 250, a credit card number of a mobile card (including a mobile credit card, check card or prepaid card) issued from the payment server 300.

The user equipment display unit 230 may display various contents such as various menu screens by using the UI and/or GUI stored in the user equipment storage unit 220 by the control of the user equipment control unit 250. Herein, the contents displayed on the user equipment display unit 230 may include menu screens including various texts or image data (including various information data) and data such as icons, a list menu, a combo box, and the like. Further, the user equipment display unit 230 may be a touch screen. Herein, the user equipment display unit 230 may include a touch sensor for sensing a touch gesture of a user. The touch sensor may be one of sensors of a capacitive type, a resistive type, and a piezoelectric type. In the case of the capacitive type, a dielectric substance coated on a surface of the touch screen is used to sense micro electricity excited as a user's body part touches the surface of the touch screen, and touch coordinates are calculated. In the case of the resistive type, two electrode plates are embedded in the touch screen, and when a user touches the screen, the upper and lower electrodes are brought into contact with each other at a touched point and a current flows, and a flow of the current is sensed and touch coordinates are calculated. In addition, the user equipment may support a pen input function. In this case, a user's gesture using an input means such as a pen instead of the user's body part can be sensed. For example, if the input means is a stylus pen including a coil therein, the user equipment may include a magnetic field sensor for sensing a magnetic field changed by the coil within the stylus pen. In this case, it is possible to sense not only a touch gesture of the user but also an approach gesture, such as hovering, of the user.

Further, the user equipment display unit 230 may be realized as at least one of a liquid crystal display (LCD), a thin film transistor-liquid crystal display (TFT-LCD), an organic light-emitting diode (OLED), a flexible display, a 3D display, an e-ink display, and an LED, and may include a driving circuit, a backlight unit, and the like for realization thereof.

Further, the user equipment display unit 230 may be constituted as a stereoscopic display unit configured to display a stereoscopic image.

Three-dimensional display methods such as a stereoscopic method (glass type), an auto-stereoscopic method (glassless type), a projection method (holographic type), and the like may be applied to the stereoscopic display unit.

Further, the user equipment display unit 230 displays, by the control of the user equipment control unit 250, the credit card number of the mobile card (including a mobile credit card, check card or prepaid card) issued from the payment server 300.

The user equipment audio output unit 240 outputs audio information included in a signal to which a predetermined signal process is performed by the user equipment control unit 250. Herein, the user equipment audio output unit 240 may include a receiver, a speaker, a buzzer, and the like.

Further, the user equipment audio output unit 240 outputs an audio guidance generated by the user equipment control unit 250.

Further, the user equipment audio output unit 240 outputs, by of the user equipment control unit 250, audio information corresponding to the credit card number of the mobile card (including a mobile credit card, check card or prepaid card) issued from the payment server 300.

The user equipment control unit 250 performs an overall control function for the user equipment 200.

Further, the user equipment control unit 250 performs the overall control function for the user equipment 200 by using programs and data stored in the user equipment storage unit 220. The user equipment control unit 250 may include a RAM, a ROM, a CPU, a GPU, and a bus, and the RAM, the ROM, the CPU, the GPU, and the like may be connected with each other by the bus. The CPU may access the user equipment storage unit 220 and perform booting by using an 0/S stored in the user equipment storage unit 220 and perform various operations by using various programs, contents, data, and the like stored in the user equipment storage unit 220.

Further, the user equipment control unit 250 performs an application process of the user of the corresponding user equipment 200 by interworking with the payment server (or card company server) 300.

Further, at the time of performing the application process, the user equipment control unit 250 can normally complete the application process of the payment server (or card company server) 300 only when an authentication function is completed by a user authentication means (including, for example, a mobile phone, a credit card, an i-PIN, e-mail, and the like).

Further, after performing the application process, the user equipment control unit 250 stores a mobile card issued from the payment server (or card company server) 300 in the user equipment storage unit 220. Herein, the user equipment control unit 250 may store the card (or mobile card) issued from the corresponding payment server 300 in a specific app previously installed in the user equipment 200 (or an app interworking with the card company server) by interworking.

Further, the user equipment control unit 250 communicates with the NFC payment terminal 100 by NFC through the user equipment communication unit 210 in order to execute the payment function. In this case, the user equipment 200 operates in a predetermined reader/writer mode in order to operate as a reader/writer.

That is, if the user equipment 200 in the predetermined reader/writer mode touches (or tags) the NFC payment terminal 100, the user equipment control unit 250 reads (or receives) the unpredictable number value (or unpredictable number) stored in the NFC payment terminal 100 connected thereto.

Further, the user equipment control unit 250 generates an authentication value by encoding the read unpredictable number value, the mobile credit card number issued from the payment server (or card company server) 300 in relation to the user of the corresponding user equipment 200 and previously stored (or registered) in the user equipment storage unit 220, and the ATC (Application Transaction Counter) through an authentication value generation key previously stored (or set) in the user equipment storage unit 220.

Herein, the user equipment control unit 250 may store the authentication value generation key in a predetermined secure area of the user equipment storage unit 220 or in a predetermined cloud server (not illustrated).

Further, the user equipment control unit 250 may perform the authentication value generation process within the predetermined secure area of the user equipment storage unit 220 or through the predetermined cloud server.

Further, the user equipment control unit 250 records (or transmits) card information including the credit card number and the generated authentication value in the storage unit 120 of the NFC payment terminal 100.

That is, while the user equipment 200 operates in the reader/writer mode, the user equipment control unit 250 generates the card information including the credit card number and the generated authentication value, and records the generated card information in the storage unit 120 (particular, SE) within the NFC payment terminal 100.

Further, the user equipment 200 may further include an interface unit (not illustrated) that interfaces with all of external devices connected with the corresponding user equipment 200. For example, the interface unit may be constituted by a wired/wireless headset port, an external charger port, a wired/wireless data port, a memory card port, a port for connecting a device including an identification module, an audio I/O (Input/Output) port, a video I/O (Input/Output) port, an earphone port, and the like. Herein, the identification module is a chip that stores various information for authenticating the authority of the user equipment 200 and may include a user identity module (UIM), a subscriber identity module (SIM), and a universal subscriber identity module (USIM). Further, the device including the identification module may be manufactured in the form of a smart card. Accordingly, the identification module may be connected with the user equipment 200 through a port. The interface unit receives data or power from an external device and then transfers the received data or power to each of the constituent elements within the user equipment 200, or enables data within the user equipment 200 to be transmitted to an external device.

Further, when the user equipment 200 is connected with an external cradle, the interface unit may serve as a passage for supplying power from the cradle to the user equipment 200 or may serve as a passage for transferring various instruction signals input from the cradle by the user to the corresponding user equipment 200. Each of the various instruction signals or the power input from the cradle may operate as a signal for enabling the user equipment 200 to recognize that it is correctly loaded in the cradle.

Further, the user equipment 200 may further include an input unit (not illustrated) configured to receive a signal generated by manipulating a button or selecting any function by the user or receive an instruction or control signal generated by manipulating a displayed screen by touch/scrolling.

The input unit is a means for receiving at least one of the user's instruction, selection, data, and information and may include numerous input keys and function keys for receiving numerical or text information and setting various functions.

Further, as the input unit, various devices such as a key pad, a dome switch, a (static/capacitive) touch pad, a touch screen, a jog wheel, a jog switch, a jog shuttle, a mouse, a stylus pen, a touch pen, and the like may be used. In particular, if the user equipment display unit 230 is formed into a touch screen, an input function may be executed, in part or in whole, by the user equipment display unit 230.

Further, each of the constituent elements (or modules) of the user equipment 200 may be software stored in a memory (or the user equipment storage unit 220) of the user equipment 200. The memory may be an embedded memory of the user equipment 200, an external memory, or a storage device of another type. Further, the memory may be a non-volatile memory. The software stored in the memory may include a set of instructions for controlling the user equipment 200 to perform a specific operation when executed.

The payment server (or card company server) 300 communicates with the NFC payment terminal 100, the user equipment 200, and the like.

Further, the payment server 300 performs an application process of the user of the user equipment 200 by interworking with the user equipment 200.

Further, the payment server 300 issues a card (or mobile card) (including, for example, a credit card, a check card, a prepaid card, and the like) to the user equipment 200 in response to a card issuance request from the user equipment 200.

If the card is issued to the user equipment 200 as such, the payment server 300 provides (or transmits) a credit card number and an authentication value generation key of the issued card to the NFC payment terminal 100, the user equipment 200, and the like.

Further, the payment server 300 manages an ATC (Application Transaction Counter) according to use of the card issued to the user equipment 200 (or execution of the payment function).

Further, the payment server 300 receives the card information, the unpredictable number, and the like transmitted from the NFC payment terminal 100.

Further, the payment server 300 generates an authentication verification value by encoding the received card information and unpredictable number and an ATC stored in the payment server 300 through an authentication value generation key previously stored in the payment server 300 in order to verify the card information. Herein, the ATC and authentication value generation key stored in the corresponding payment server 300 are in the same state as the ATC and authentication value generation key stored in the NFC payment terminal 100.

Further, the payment server 300 checks (or determines) whether the authentication value in the card information transmitted from the NFC payment terminal 100 is identical with (or the same as) the authentication verification value generated in the corresponding payment server 300.

As a result of checking (or determination), if the authentication value in the card information transmitted from the NFC payment terminal 100 is not identical with the authentication verification value generated in the payment server 300, the payment server 300 transmits transaction failure information to the NFC payment terminal 100.

Further, as a result of checking (or determination), if the authentication value in the card information transmitted from the NFC payment terminal 100 is identical with the authentication verification value generated in the payment server 300, the payment server 300 determines a transaction as normal and transmits transaction approval information to the NFC payment terminal 100.

Further, the payment server 300 can be realized as a web server, a database server, a proxy server, or the like. Further, a network load balancing mechanism may be installed in the payment server 300, or one or more of various software that enables the payment server 300 to operate in the Internet or in another network may be installed in the payment server 300. Thus, the payment server 300 can be realized as a computerized system. Further, the network may be an http network, or may be a private line, an intranet, or any other network. Moreover, the payment server 300 may be connected with the user equipment 200 by secure network to insure that data are not subject to attack by any hacker or other third party. Further, the payment server 300 may include a plurality of database servers. The database servers may be connected with the payment server 300 separately via any type of network connection including a distributed database server architecture.

Further, a processor installed in the NFC payment terminal 100, the user equipment 200, the payment server 300, and the like according to the present invention may process a program instruction for performing the method according to the present invention. In an embodiment, the processor may be a single-threaded processor. In another embodiment, the processor may be a multi-threaded processor. Further, the processor can process instructions stored in the memory or storage device.

As such, the payment function can be executed by the user equipment operating as a reader/writer and the NFC payment terminal (or POS terminal) operating as a card.

Further, it is possible to provide an open payment system capable of autonomously executing the payment function without being affected by a mobile carrier or mobile phone manufacturer that manages and controls a USIM (Universal Subscriber Identity Module) or an SE (Secure Element).

Hereinafter, a control method of a reverse NFC payment system according to the present invention will be described in detail with reference to FIG. 1 to FIG. 9.

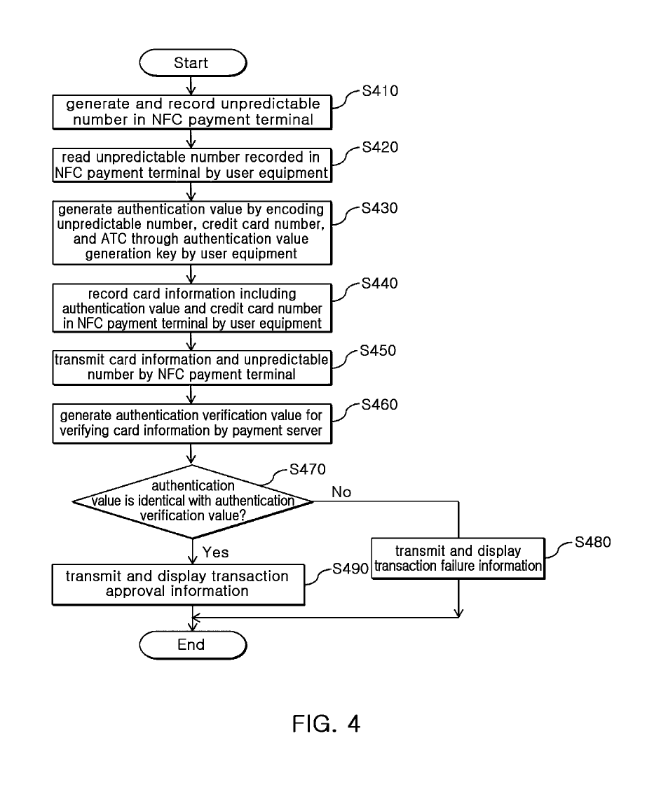

FIG. 4 is a flowchart illustrating a control method of a reverse NFC payment system according to a first embodiment of the present invention.

First, the NFC payment terminal 100 generates an unpredictable number (UN) required to generate payment authentication information. In this case, the NFC payment terminal 100 operates in a predetermined card emulation mode in order to operate as a card.

Further, the NFC payment terminal 100 stores the generated unpredictable number in the storage unit 120 within the NFC payment terminal 100.

For example, the NFC payment terminal 100 in the predetermined card emulation mode generates the unpredictable number required to generate payment authentication information and stores the generated unpredictable number in the SE as the storage unit 120 within the NFC payment terminal 100 (S410).

Then, the user equipment 200 communicates with NFC payment terminal 100 by NFC in order to execute a payment function. In this case, the user equipment 200 operates in a predetermined reader/writer mode in order to operate as a reader/writer.

Further, the user equipment 200 reads (or receives) the unpredictable number value (or unpredictable number) stored in the NFC payment terminal 100 connected thereto.

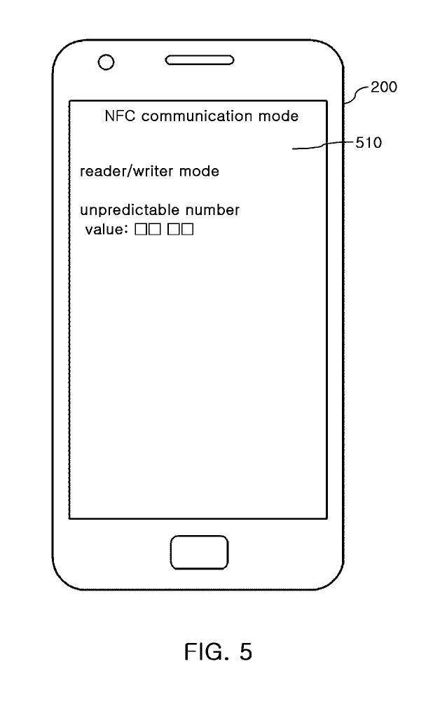

For example, when the user equipment 200 in the predetermined reader/writer mode touches (or tags) the NFC payment terminal 100, the user equipment 200 reads an unpredictable number value 510 stored in the NFC payment terminal 100 as illustrated in FIG. 5 (S420).

Then, the user equipment 200 generates an authentication value by encoding the read unpredictable number value and a mobile credit card number issued from the payment server (or card company server) 300 in relation to the user of the corresponding user equipment 200 and previously stored (or registered) in the user equipment 200, and an ATC (Application Transaction Counter) through an authentication value generation key previously stored (or set) in the user equipment 200 at the time of issuance of the corresponding mobile card. In this case, the user equipment 200 may store the authentication value generation key in a predetermined secure area of the user equipment 200 or in a predetermined cloud server (not illustrated). Further, the user equipment 200 may perform the authentication value generation process within the predetermined secure area of the corresponding user equipment 200 or through the predetermined cloud server.

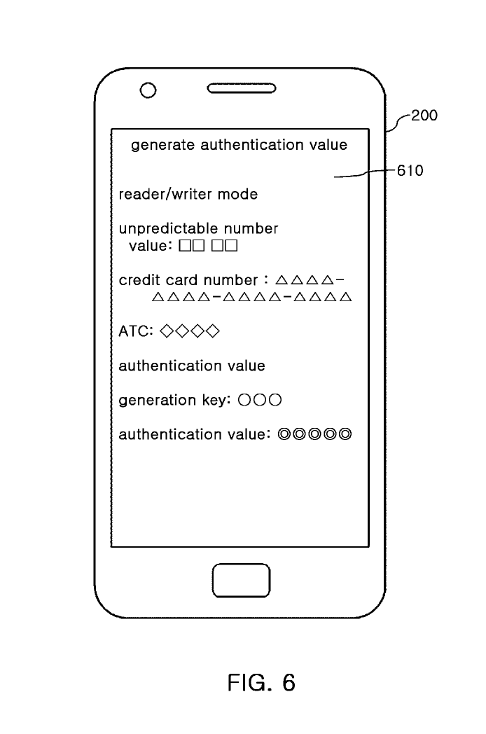

For example, as illustrated in FIG. 6, the user equipment 200 generates an authentication value 610 by encoding the unpredictable number value read from the NFC payment terminal 100 and the credit card number and ATC stored in the user equipment 200 through the authentication value generation key (S430).

Then, the user equipment 200 records (or transmits) card information including the credit card number and the generated authentication value in the storage unit 120 of the NFC payment terminal 100.

That is, while the user equipment 200 operates in the reader/writer mode, the user equipment 200 generates the card information including the credit card number and the generated authentication value and records the generated card information in the storage unit 120 within the NFC payment terminal 100.

As an example, the user equipment 200 in the predetermined reader/writer mode generates card information including the credit card number and the generated authentication value and records the generated card information in the SE as the storage unit 120 within the NFC payment terminal 100 (S440).

Then, the NFC payment terminal 100 transmits the card information recorded in the storage unit 120, the unpredictable number stored in the storage unit 120, and the like to the payment sever (or card company sever) 300.

As an example, the NFC payment terminal 100 reads the card information and unpredictable number recorded in the SE as the storage unit 120 and transmits the read card information and unpredictable number to the payment server 300 (S450).

Then, the payment server 300 receives the card information and unpredictable number transmitted from the NFC payment terminal 100.

Further, the payment server 300 generates an authentication verification value by encoding the received card information and unpredictable number and an ATC stored in the payment server 300 through an authentication value generation key previously stored in the corresponding payment server 300 in order to verify the card information.

As an example, the payment server 300 generates the authentication verification value by encoding the credit card number in the card information transmitted from the NFC payment terminal 100, and the unpredictable number transmitted from the NFC payment terminal 100, and the ATC through the authentication value generation key (S460).

Then, the payment server 300 checks (or determines) whether the authentication value in the card information transmitted from the NFC payment terminal 100 is identical with (the same as) the authentication verification value generated in the payment server 300.

As an example, the payment server 300 checks whether the authentication value in the card information transmitted from the NFC payment terminal 100 is identical with the authentication verification value generated in corresponding the payment server 300 (S470).

As a result of checking (or determination), if the authentication value in the card information transmitted from the NFC payment terminal 100 is not identical with the authentication verification value generated in the corresponding payment server 300, the payment server 300 transmits transaction failure information to the NFC payment terminal 100.

Further, the NFC payment terminal 100 receives the transaction failure information transmitted from the payment server 300 and displays the received transaction failure information.

As an example, if the authentication value in the card information transmitted from the NFC payment terminal 100 is not identical with the authentication verification value generated in the payment server 300, the payment server 300 transmits a transaction failure message to the NFC payment terminal 100. Further, the NFC payment terminal 100 receives the transaction failure message transmitted from the payment server 300 and displays the received transaction failure message (S480).

Further, as a result of checking (or determination), if the authentication value in the card information transmitted from the NFC payment terminal 100 is identical with the authentication verification value generated in the corresponding payment server 300, the payment server 300 determines a transaction as normal and transmits transaction approval information to the NFC payment terminal 100.

Further, the NFC payment terminal 100 receives the transaction approval information transmitted from the payment server 300 and displays the received transaction approval information.

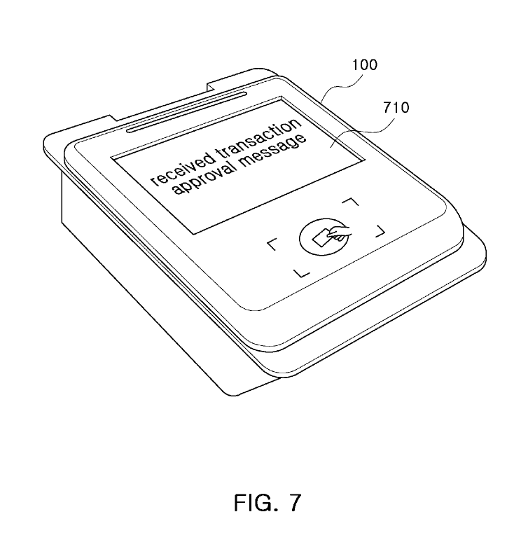

As an example, if the authentication value in the card information transmitted from the NFC payment terminal 100 is identical with the authentication verification value generated in the corresponding payment server 300, the payment server 300 transmits a transaction approval message to the NFC payment terminal 100. Further, the NFC payment terminal 100 receives the transaction approval message transmitted from the payment server 300 and displays the received transaction approval message 710 as illustrated in FIG. 7 (S490).

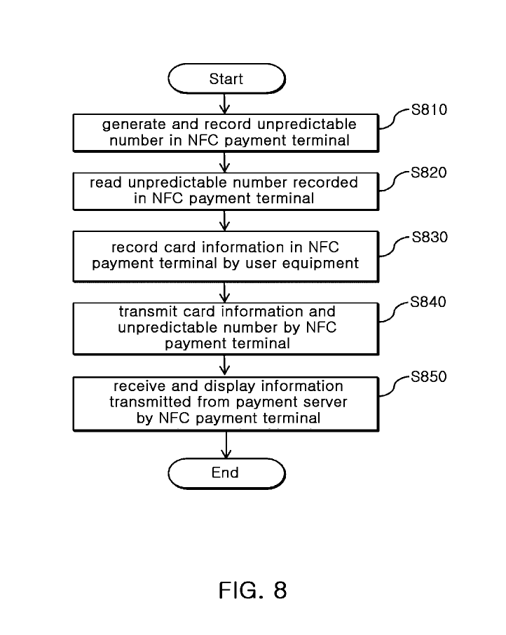

FIG. 8 is a flowchart illustrating a control method of a reverse NFC payment system according to a second embodiment of the present invention.

First, the NFC payment terminal 100 generates an unpredictable number required to generate payment authentication information. In this case, the NFC payment terminal 100 operates in a predetermined card emulation mode in order to operate as a card.

Further, the NFC payment terminal 100 stores the generated unpredictable number in the storage unit 120 within the NFC payment terminal 100.

As an example, the NFC payment terminal 100 in the predetermined card emulation mode generates the unpredictable number required to generate payment authentication information and stores the generated unpredictable number in the SE as the storage unit 120 within the NFC payment terminal 100 (S810).

Then, if the NFC payment terminal 100 is touched (or tagged) by the user equipment 200 in order to execute the payment function, the unpredictable number value (or unpredictable number) stored in the corresponding NFC payment terminal 100 is read by the user equipment 200.

As an example, when the user equipment 200 in a predetermined reader/writer mode touches (or tags) the NFC payment terminal 100, the unpredictable number value (or unpredictable number) stored in the corresponding NFC payment terminal 100 is read by the user equipment 200 (S820).

Then, the NFC payment terminal 100 records card information of the user equipment 200 in the SE as the storage unit 120 within the NFC payment terminal 100. In this case, the card information includes an authentication value generated in the user equipment 200 and a credit card number issued to the corresponding user equipment 200. Herein, the authentication value may be a value generated by encoding the unpredictable number read from the NFC payment terminal 100 and a credit card number and ATC previously stored in the user equipment 200 through an authentication value generation key stored in the corresponding user equipment 200.

As an example, the user equipment 200 in the predetermined reader/writer mode generates the card information including the credit card number and the generated authentication value. Then, the user equipment 200 records the card information in the SE of the NFC payment terminal 100 (S830).

Then, the NFC payment terminal 100 transmits the card information recorded in the storage unit 120, the unpredictable number stored in the storage unit 120, and the like to the payment sever (or card company sever) 300.

As an example, the NFC payment terminal 100 reads the card information and unpredictable number recorded in the SE as the storage unit 120 and transmits the read card information and unpredictable number to the payment server 300 (S840).

Then, the NFC payment terminal 100 receives transaction failure information (or a transaction failure message) or transaction approval information (or a transaction approval message) transmitted from the payment server 300 in response to the transmitted card information unpredictable number, and the like.

Further, the NFC payment terminal 100 displays the received transaction failure information (or transaction failure message) or transaction approval information (or transaction approval message).

As an example, the NFC payment terminal 100 receives the transaction failure message transmitted from the payment server 300 in response to the transmitted card information, unpredictable number, and the like and displays the received transaction failure message.

For another example, the NFC payment terminal 100 receives the transaction approval message transmitted from the NFC payment server 300 in response to the transmitted card information, unpredictable number, and the like and displays the received transaction approval message (S850)

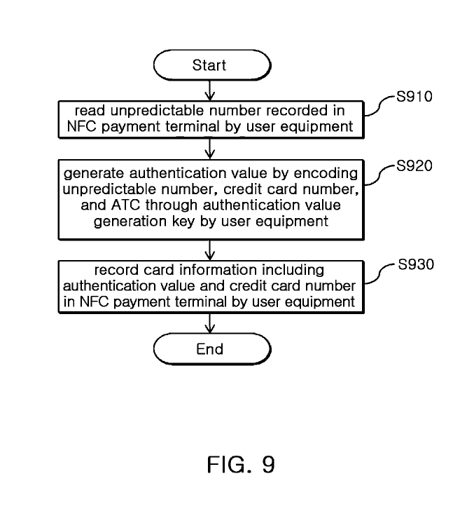

FIG. 9 is a flowchart illustrating a control method of a reverse NFC payment system according to a third embodiment of the present invention.

First, the user equipment 200 communicates with NFC payment terminal 100 by NFC in order to execute a payment function. In this case, the user equipment 200 operates in a predetermined reader/writer mode in order to operate as a reader/writer.

Further, the user equipment 200 reads (or receives) an unpredictable number value (or unpredictable number) stored in the NFC payment terminal 100 connected thereto. Herein, the unpredictable number value stored in the NFC payment terminal 100 is information (or a value) required to generate payment authentication information, and the NFC payment terminal 100 may operate in a predetermined card emulation mode in order to operate as a card.

As an example, when the user equipment 200 in the predetermined reader/writer mode touches (or tags) the NFC payment terminal 100, the user equipment 200 reads the unpredictable number value stored in the NFC payment terminal 100 (S910).

Then, the user equipment 200 generates an authentication value by encoding the read unpredictable number value, a mobile credit card number issued from the payment server (or card company server) 300 in relation to the user of the user equipment 200 and previously stored (or registered) in the user equipment 200, and an ATC through an authentication value generation key previously stored (or set) in the user equipment 200 at the time of issuance of the mobile card. In this case, the user equipment 200 may store the authentication value generation key in a predetermined secure area of the user equipment 200 or in a predetermined cloud server (not illustrated). Further, the user equipment 200 may perform the authentication value generation process within the predetermined secure area of the user equipment 200 or through the predetermined cloud server.

As an example, the user equipment 200 generates the authentication value by encoding the unpredictable number read from the NFC payment terminal 100 and the credit card number and ATC stored in the corresponding user equipment 200 through the authentication value generation key (S920).

Then, the user equipment 200 records (or transmits) card information including the credit card number and the generated authentication value in the storage unit 120 of the NFC payment terminal 100.

That is, while the user equipment 200 operates in the reader/writer mode, the user equipment 200 generates the card information including the credit card number and the generated authentication value and records the generated card information in the storage unit 120 within the NFC payment terminal 100.

As an example, the user equipment 200 in the predetermined reader/writer mode generates card information including the credit card number and the generated authentication value and records the generated card information in the SE as the storage unit 120 within the NFC payment terminal 100 (S930).

The user equipment for reverse NFC payment, the NFC payment terminal, and the reverse NFC payment system including the same according to the embodiments of the present invention may be prepared with a computer program, and codes and code segments configuring the computer program may be easily deduced by a computer programmer in the art. Further, the corresponding computer program is stored in non-transitory computer readable storage media, and read and executed by the computer or the NFC payment terminal, the user equipment, the payment server, and the like according to the embodiments of the present invention to implement the user equipment for reverse NFC payment, the NFC payment terminal, and the reverse NFC payment system including the same.

The non-transitory computer readable storage media include a magnetic storage medium, an optical storage medium, and a carrier wave medium. The computer program implementing the user equipment for reverse NFC payment, the NFC payment terminal, and the reverse NFC payment system including the same according to the embodiments of the present invention may be stored and installed in an embedded memory of the NFC payment terminal, the user equipment, the payment server, and the like. Alternatively, an external memory such as a smart card storing and installing the computer program implementing the user equipment for reverse NFC payment, the NFC payment terminal, and the reverse NFC payment system including the same according to the embodiment of the present invention may be installed on the NFC payment terminal, the user equipment, the payment server, and the like through an interface.

As described above, according to the embodiments of the present invention, since a user equipment operates as a reader/writer and an NFC payment terminal (or POS terminal) operates as a card so as to execute a payment function, it is possible to simplify a payment process and thus possible to improve satisfaction of a user.

Further, as described above, since the embodiments of the present invention provide an open payment system capable of autonomously executing a payment function without being affected by a mobile carrier or mobile phone manufacturer that manages and controls a USIM (Universal Subscriber Identity Module) or an SE (Secure Element), it is possible to autonomously provide a mobile card service without making an alliance or settling costs with the mobile carrier or mobile phone manufacturer. Thus, it is possible to unify customer management and also reduce costs required to issue cards.

Hereinabove, although the present invention is described by specific matters such as concrete components, and the like, embodiments, and drawings, they are provided only for assisting in the entire understanding of the present invention. Therefore, the present invention is not limited to the embodiments. Various modifications and changes may be made by those skilled in the art to which the present invention pertains from this description. Therefore, the spirit of the present invention should not be limited to the above-described embodiments and the following claims as well as all modified equally or equivalently to the claims are intended to fall within the scope and spirit of the invention.

### INDUSTRIAL APPLICABILITY

According to the present invention, since a user equipment operates as a reader/writer and an NFC payment terminal (or POS terminal) operates as a card so as to execute a payment function, it is possible to simplify a payment process and thus possible to improve satisfaction of a user. Further, it is possible to autonomously provide a mobile card service without making an alliance or settling costs with a mobile carrier or mobile phone manufacturer. Thus, it is possible to unify customer management and also reduce costs required to issue cards. Accordingly, the present invention may be widely used in a payment field, a POS terminal field, a user equipment field, a payment server field, and the like.

What is claimed is:

1. A control method of a user equipment comprising:
reading, by means of a control unit of the user equipment, an unpredictable number (UN) stored in a secure element (SE) of an NFC payment terminal by tagging the NFC payment terminal;
generating, by means of the control unit of the user equipment, an authentication value by encoding the read unpredictable number and a credit card number and an ATC(Application Transaction Counter) stored in a storage unit of the user equipment through the authentication value generation key stored in the storage unit of the user equipment; and
recording, by means of the control unit of the user equipment, card information including the credit card number and the generated authentication value in the SE of the NFC payment terminal.

2. A reverse NFC payment system comprising:
an NFC payment terminal configured to operate in a predetermined card emulation mode in order to operate as a card, generate an unpredictable number required to generate payment authentication information, and store the generated unpredictable number in an SE; and
a user equipment configured to operate in a predetermined reader/writer mode in order to operate as a reader/writer, read the unpredictable number stored in the SE of the NFC payment terminal, generate an authentication value by encoding the read unpredictable number, a credit card number, and an ATC through an authentication value generation key, and records card information including the credit card number and the generated authentication value in the SE of the NFC payment terminal.

3. The reverse NFC payment system of claim 2, wherein the user equipment performs the authentication value generation process within a predetermined secure area of the user equipment.

4. The reverse NFC payment system of claim 2, further comprising:
a payment server configured to receive the card information and the unpredictable number recorded in the SE and transmitted from the NFC payment terminal, generate an authentication verification value by encoding the received card information and unpredictable number and an ATC previously stored in the payment server through an authentication value generation key previously stored in the payment server in order to verify the card information, and checks whether the authentication value in the card information transmitted from the NFC payment terminal is identical with the generated authentication verification value.

5. The reverse NFC payment system of claim 4, wherein when the authentication value in the card information transmitted from the NFC payment terminal is not identical with the generated authentication verification value, the payment server transmits transaction failure information to the NFC payment terminal, and
the NFC payment terminal receives the transaction failure information transmitted from the payment server and displays the received transaction failure information.

6. The reverse NFC payment system of claim 4, wherein when the authentication value in the card information transmitted from the NFC payment terminal is identical with the generated authentication verification value, the payment server determines a transaction as normal and transmits transaction approval information to the NFC payment terminal, and
the NFC payment terminal receives the transaction approval information transmitted from the payment server and displays the received transaction approval information.

7. A control method of a reverse NFC payment system, comprising:
operating in a predetermined card emulation mode in order to operate as a card and generating an unpredictable number required to generate payment authentication information, by means of an NFC payment terminal;
storing the generated unpredictable number in an SE, by means of the NFC payment terminal;
operating in a predetermined reader/writer mode in order to operate as a reader/writer and reading the unpredictable number stored in the SE of the NFC payment terminal after tagging the NFC payment terminal, by means of a user equipment;
generating an authentication value by encoding the read unpredictable number, a credit card number, and an ATC through an authentication value generation key, by means of the user equipment; and
recording card information including the credit card number and the generated authentication value in the SE of the NFC payment terminal, by means of the user equipment.

8. The control method of a reverse NFC payment system of claim 7, wherein the authentication value generation key is stored in a predetermined secure area of the user equipment or a storage unit of a cloud server.

9. The control method of a reverse NFC payment system of claim 7, further comprising:
transmitting the card information and the unpredictable number recorded in the SE of the NFC payment terminal to a payment server, by means of the NFC payment terminal; generating an authentication verification value by encoding the transmitted card information and unpredictable number and an ATC previously stored in the payment server through an authentication value generation key previously stored in the payment server in order to verify the card information, by means of the payment server;
checking whether the authentication value in the card information transmitted from the NFC payment terminal is identical with the generated authentication verification value, by means of the payment server;
as a result of checking, when the authentication value in the card information transmitted from the NFC payment terminal is identical with the generated authentication verification value, determining a transaction as normal and transmitting transaction approval information to the NFC payment terminal, by means of the payment server; and
displaying the transaction approval information transmitted from the payment server, by means of the NFC payment terminal.

10. The control method of a reverse NFC payment system of claim 9, further comprising:
as a result of checking, when the authentication value in the card information transmitted from the NFC payment terminal is not identical with the generated authentication verification value, transmitting transaction failure information to the NFC payment terminal, by means of the payment server; and
displaying the transaction failure information transmitted from the payment server, by means of the NFC payment terminal.

11. The control method of a reverse NFC payment system of claim 7, wherein recording card information includes:
generating, by means of the user equipment while operating in a predetermined reader/writer mode, the card information including the credit card number and the generated authentication value; and
recording, by means of the user equipment, the generated card information in the SE of the NFC payment terminal.
